(19) United States
(12) Patent Application Publication
(10) Pub. No.: US 2026/0028940 A1
(43) Pub. Date: Jan. 29, 2026

(54) Method for starting an internal combustion engine comprising a camshaft associated with an electric variable valve timing device

(71) Applicant: Schaeffler Technologies AG & Co. KG, Herzogenaurach (DE)

(72) Inventors: Jonathan LORRE, Toulouse (FR); Fabien JOSEPH, Castanet Tolosan (FR)

(73) Assignee: Schaeffler Technologies AG & Co. KG, Herzogenaurach (DE)

(21) Appl. No.: 19/228,353

(22) Filed: Jun. 4, 2025

(30) Foreign Application Priority Data
Jul. 29, 2024 (FR) FR2408371

(51) Int. Cl. F02D 13/02; F01L 1/047; F01L 1/344; F02D 41/00; F02D 41/26

(52) U.S. Cl. CPC F02D 13/0215; F01L 1/047; F01L 1/344; F02D 41/0002; F02D 41/009; F02D 41/26; F02D 2041/001

(57) ABSTRACT

A method for starting an internal combustion engine including a camshaft provided with an electric continuous variable valve timing device. The method includes: (a) applying a maximum voltage to the electric actuator, then (b1) initiating a timer Ts during which a maximum voltage continues to be applied to said actuator and, in parallel, (b2) starting a synchronization of the combustion engine, then (c) if the timer expires before the end of the synchronization of the combustion engine, incrementing the value of the failure counter and reiterating (a) to (c) if the value of the failure counter is less than a predetermined number Nmax, otherwise, stopping the application of a voltage to the actuator, the combustion engine being synchronized.

### CROSS REFERENCE TO RELATED APPLICATIONS

This application claims priority to French Application No. FR2408371, filed Jul. 29, 2024, the contents of such application being incorporated by reference herein.

### FIELD OF THE INVENTION

The present invention relates to a method for starting an internal combustion engine comprising at least one camshaft associated with an electric continuous variable valve timing device.

### PRIOR ART

In an operating cycle of a four-stroke internal combustion engine, it is necessary to know the position of the crankshaft accurately in order to be able to synchronize various actions such as fuel injection, spark plug control, management of timing members, etc. This makes it possible to optimize the efficiency of combustion and reduce fuel consumption and harmful emissions. In other words, an internal combustion engine must be synchronized (phased) in order to determine and optimize the best time to burn the fuel in the cylinder for the optimization of emissions, consumption, etc.

Synchronization or phasing of the engine is generally achieved by combining information from a crankshaft position sensor and from a camshaft position sensor that detect targets such as teeth on toothed wheels.

To do this, a crankshaft conventionally comprises a toothed wheel, or crankshaft target, which typically comprises a set of teeth evenly distributed about its circumference (for example from 36 to 120 teeth), and the teeth of which are detected by a sensor referred to as the CRK sensor. The toothed wheel rigidly connected to the crankshaft comprises a reference portion, also referred to as the singularity or signature, without teeth and in the form of a recess or a long tooth, also referred to as the GAP, which is the term used below. By detecting the teeth passing in front of the sensor and counting the number of teeth from the GAP during engine rotation, it is possible to know the position of the crankshaft over a 360° crankshaft revolution, in other words 360° C. RK, the angle of rotation of the crankshaft being expressed in ° CRK.

The crankshaft target provided with teeth thus has a singularity that makes it possible to know the engine position to within 360° C. RK. However, an engine cycle (for a so-called four-stroke engine) takes place over two complete rotations of the crankshaft and knowledge of the angular position of the crankshaft is therefore insufficient to determine the position of the engine with respect to one engine cycle.

In this case, it is known practice to combine the information obtained from the rotation of the crankshaft with angular position information corresponding to a camshaft, which is rotated by the crankshaft with a reduction ratio of two so that the camshaft completes one full rotation when the crankshaft completes two. The additional information from the camshaft thus makes it possible to determine correct phasing. The angle of rotation of the camshaft is expressed in ° CAM, and it will be noted that one revolution of 360° C. AM is equivalent to 720° C. RK. By positioning a toothed wheel on the camshaft, which toothed wheel also has a rotational asymmetry, the corresponding information, cross-referenced with the information about the position of the crankshaft, makes it possible to deduce the state of the engine cycle accurately.

In addition, variable valve timing is a technology that makes it possible to vary a plurality of parameters in an internal combustion engine, namely the timing of the valve opening/closing events, the duration of the valve opening/closing events, and/or the valve lift of the intake and exhaust valves.

Continuous variable valve timing can particularly be implemented by varying the angular position of an intake camshaft or an exhaust camshaft in one direction or the other relative to an angular position of a crankshaft of the engine. This changes the phase angle of the camshaft and modifies the valve overlap, the period during which the intake and exhaust valves are simultaneously open. By modifying the valve overlap, continuous variable valve timing can improve engine breathing, reduce pumping losses, increase volumetric efficiency and control the residual gas fraction.

Many combustion engines have a camshaft associated with (continuous) variable valve timing, which is abbreviated to (C)VVT.

As is known, a continuous variable valve timing device comprises an actuator for modifying the position of the camshaft.

The variable valve timing device is controlled on the basis of the position of the tooth edges of a camshaft target and cannot therefore be controlled correctly before the engine has been synchronized.

A mechanical actuator conventionally comprises a return spring which, when the associated combustion engine is switched off, places the camshaft in a reference angular position relative to the crankshaft. The combustion engine can then be started by synchronization with the reference angular position of the camshaft relative to the crankshaft.

Electric actuators also exist. In the absence of a return member, the angular position of the camshaft is not known after the engine has been switched off.

In this case, it is no longer possible to synchronize the combustion engine using a crankshaft and a camshaft provided with such an electric actuator, as set out above.

When an engine only has electric devices on its camshafts, there is thus a need to determine the angular position of the camshafts provided with such devices.

More generally, there is a need to determine the angular position of such an electric device when the angular position of a camshaft provided with a mechanical device is no longer known, for example because an angular position sensor associated with the device is defective.

There is therefore a need to improve the starting of an internal combustion engine comprising at least one camshaft provided with an electric continuous variable valve timing device.

### SUMMARY OF THE INVENTION

One idea behind an aspect of the invention stems from the observation that when a predetermined voltage, referred to as the maximum voltage, is applied to such an electric device for a predetermined duration, the electric device then has a so-called limit configuration associated with a predetermined angular position, referred to as the limit angular position.

According to a first aspect of the invention, a method is proposed for starting an internal combustion engine comprising a camshaft provided with an electric continuous variable valve timing device.

The electric device comprises an electric actuator configured to modify the angular position of the camshaft, the camshaft having a so-called limit configuration associated with a predetermined angular position, referred to as the limit angular position, when a predetermined voltage, referred to as the maximum voltage, is applied to said actuator for a predetermined duration Tb.

### The Method Comprises:

/a/ a step of applying the maximum voltage to said electric actuator for a duration greater than the predetermined duration, then
   /b1/ a step (Ed) of initiating a timer Ts, referred to as the safety timer, of a duration Tmax during which a maximum voltage continues to be applied to said actuator and, in parallel,
   /b2/ a step (Es) of starting a synchronization of the combustion engine on the basis of position data associated with the limit angular position, then
/c/ if the timer expires before the end of the synchronization of the combustion engine, a step of incrementing the value of the failure counter and reiterating steps /a/ to /c/ if the value of the failure counter is less than a predetermined number Nmax,
   otherwise the engine is synchronized and the supply of the so-called limit voltage to said actuator is stopped (Estop).

Preferably, the duration of application of the maximum voltage is determined on the basis of an angular rotation speed of the actuator and a maximum angular displacement in order to reach the limit angular position.

Advantageously, the method comprises, prior to step /a/, a step of determining that only electric actuators are available for synchronizing the engine.

According to a second aspect of the invention, a computer program product is proposed, comprising program code instructions recorded on a computer-readable medium such as a processor, a controller or a microcontroller for implementing the steps of the method as described above when said program is implemented by said computer such as a processor, a controller or a microcontroller.

According to a third aspect of the invention, an electronic module is proposed for starting an internal combustion engine comprising a camshaft provided with an electric continuous variable valve timing device

As previously, the electric device comprises an electric actuator configured to modify the angular position of the camshaft, the camshaft having a so-called limit configuration associated with a predetermined angular position, referred to as the limit angular position, when a predetermined voltage, referred to as the maximum voltage, is applied to said actuator for a predetermined duration Tb.

### The Electronic Module is Configured to:

/a/ apply a maximum voltage to said electric actuator for a duration greater than the predetermined duration, then
   /b1/ initiate a timer Ts, referred to as the safety timer, of a duration Tmax during which a maximum voltage continues to be applied to said actuator and, in parallel,
   /b2/ starting a synchronization of the combustion engine on the basis of position data associated with the limit angular position, then
/c/ if the timer expires before the end of the synchronization of the combustion engine, incrementing the value of the failure counter and reiterating steps /a/ to /c/ if the value of the failure counter is less than a predetermined number Nmax,
otherwise, stopping the application of a so-called limit voltage to said actuator, the combustion engine being synchronized.

According to another aspect of the invention, a combustion engine comprising an electronic module according to an aspect of the invention is proposed.

According to yet another aspect of the invention, a vehicle comprising a combustion engine according to an aspect of the invention is proposed.

### BRIEF DESCRIPTION OF THE FIGURES

Further features and advantages of aspects of the invention will become apparent on reading the following detailed description, which will be more clearly understood with reference to the appended drawings, in which:

FIG. 1 is a schematic view of one embodiment of an electronic device according to the invention,

FIG. 2 illustrates a method according to an aspect of the invention implemented in the device shown in FIG. 1.

FIG. 3 illustrates an implementation of the method in FIG. 2.

### DETAILED DESCRIPTION OF THE INVENTION

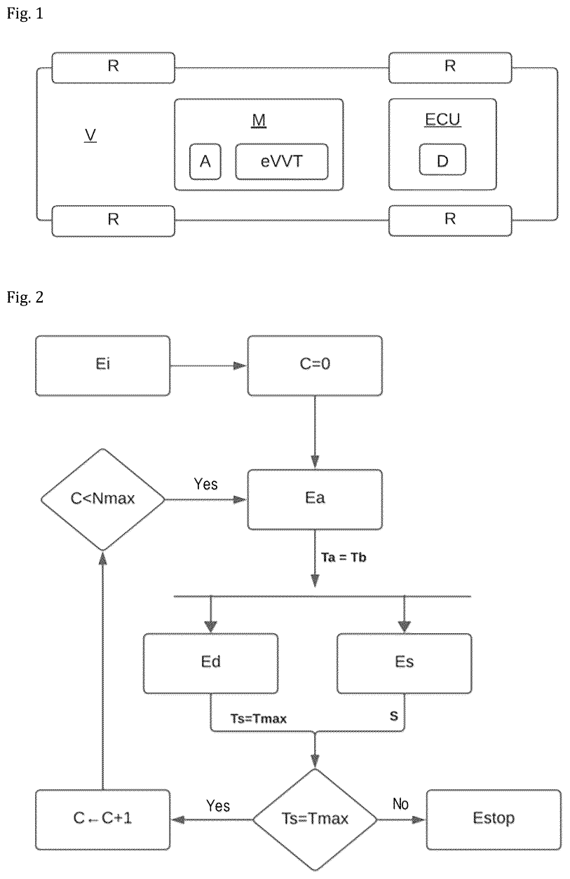

With reference to FIG. 1 and FIG. 2, a combustion engine M is illustrated, mounted in a vehicle V with wheels R driven by the combustion engine M mounted in said vehicle.

The combustion engine M is an internal combustion engine, for example a four-stroke engine, comprising an intake camshaft and an exhaust camshaft.

One of the two camshafts, denoted A, is provided with an electric variable valve timing device eVVT. The other camshaft can for example also be provided with an electric variable valve timing device eVVT. An aspect of the invention also applies if the other camshaft is provided with a mechanical continuous variable valve timing device and the sensor associated with the other camshaft is defective.

The electric device eVVT comprises an electric actuator configured to modify the angular position of the camshaft, the camshaft having a so-called limit configuration associated with a predetermined angular position, referred to as the limit angular position, when a predetermined voltage, referred to as the maximum voltage, is applied to said electric device for a predetermined duration.

For example, the predetermined angular position is 160° C. RK.

The combustion engine M is controlled by an engine control unit, ECU.

The engine control unit ECU comprises an electronic module D according to an aspect of the invention.

### The Electronic Module D is Configured to:

/a/ apply a maximum voltage Ea to said electric actuator for a duration greater than the predetermined duration, then
   /b1/ a step Ed of initiating a timer Ts, referred to as the safety timer, of a duration Tmax during which a maximum voltage continues to be applied to said actuator and, in parallel,
   /b2/ a step Es of starting a synchronization of the combustion engine on the basis of position data associated with the limit angular position, and then
if the timer expires before the end of the synchronization of the combustion engine, a step of incrementing the value of the failure counter and reiterating steps /a/ to /c/ if the value of the failure counter is less than a predetermined number (Nmax),
otherwise, the engine is synchronized and the application of the limit voltage to said actuator is stopped (Estop).

The combustion engine is synchronized using the position of the singularity of the crankshaft target and the position of the theoretical tooth edges generated by a sensor associated with the camshaft target in the limit position.

The electronic module D can be implemented in the form of a computer program product, comprising program code instructions recorded on a computer-readable medium such as a processor, a controller or a microcontroller for implementing the steps of the method P when said program is implemented by said computer such as a processor, a controller or a microcontroller.

The step of synchronizing the combustion engine on the basis of position data associated with a known position of a camshaft is known to a person skilled in the art.

The duration of application of the maximum voltage can be determined on the basis of knowledge of an angular rotation speed of the actuator and a maximum angular displacement in order to reach the limit angular position.

The maximum number Nmax makes it possible to avoid breaking the electric continuous variable valve timing device by moving the electric actuator to a limit position of the camshaft too many times. Nmax=3 can for example be selected.

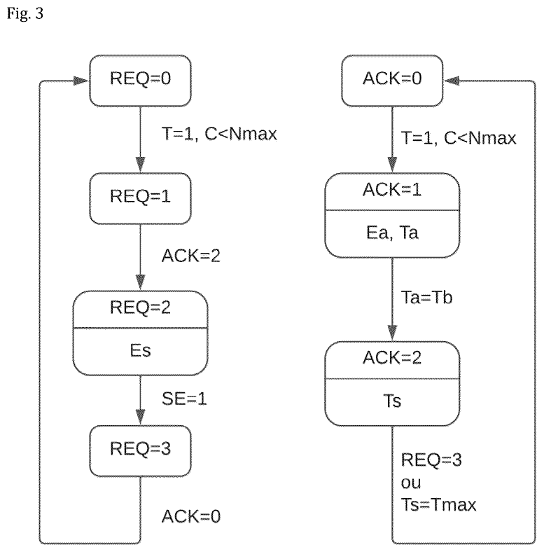

FIG. 3 illustrates one possible implementation of a method according to the invention.

FIG. 3 illustrates two state machines, REQ and ACK.

The two state machines REQ and ACK can for example be implemented in the electronic control unit.

The state machines can read the state of a variable SE indicating the engine synchronization, which is equal to 1 when the engine is synchronized and 0 otherwise.

The state machine REQ comprises three states:
an initial state REQ=0 indicating that there is no need to implement the method according to an aspect of the invention;
a state REQ=1 indicating that there is a need to modify the angular position of the camshaft;
a state REQ=2 indicating that the synchronization step Es has started, the switch to the state REQ=2 resulting in a step Es of starting a synchronization of the combustion engine on the basis of position data associated with the limit angular position, the synchronization of said engine ending with the value 1 being assigned to the variable.
a state REQ=3 indicating that a synchronized state has been reached.

### The State Machine ACK Comprises Three States:

an initial state ACK=0 indicating that there is no need to implement the method according to an aspect of the invention;
a state ACK=1 indicating that a request to move the camshaft to a limit configuration has been received, the switch to the state ACK=1 starting with the initiation of a timer Ta as the input action and the application Ea of the maximum voltage to said electric actuator for the predetermined duration Tb;
a state ACK=2 indicating that the camshaft is in a limit configuration, the switch to the state ACK=2 resulting in the initiation of a timer Ts as the input action and the application of the maximum voltage to said electric actuator.

The state machine REQ has access to a variable T, equal to 1 when only electric actuators are available for synchronization, and equal to 0 otherwise.

The state machine REQ can read a counter C and compare it with a predetermined maximum number Nmax.

The state machine REQ can know the state of the synchronization of the combustion engine. When a variable SE is equal to 1, this indicates a synchronized state of the combustion engine.

### Transitions of the State Machine REQ:

from state REQ=0 to state REQ=1: the variable T is equal to 1 and the counter C is strictly less than Nmax;
from state REQ=1 to state REQ=2: when the state machine ACK switches to state ACK=2;
from state REQ=2 to state REQ=3: when the variable SE is equal to 1;
from state REQ=3 to state REQ=0: when the state machine ACK switches to state ACK=0.

### Transitions of the State Machine ACK:

from state ACK=0 to state ACK=1: when the state machine REQ switches to state REQ=1 and the counter C is strictly less than Nmax;
from state ACK=1 to state ACK=2: when the timer Ta reaches a predetermined value Tb;
from state ACK=2 to state ACK=0: when the state machine REQ switches to state REQ=3, in which case the counter C is reset, or the timer Ts reaches a predetermined value Tmax, in which case the counter C is incremented.

Of course, the invention is not limited to the examples that have just been described, and numerous modifications can be made to these examples without departing from the scope of the invention. In addition, the different features, forms, variants and embodiments of the invention can be combined with each other in various combinations provided that they are not incompatible or mutually exclusive.

1. A method for starting an internal combustion engine comprising a camshaft provided with an electric continuous variable valve timing device,
the electric device comprising an electric actuator configured to modify the angular position of the camshaft, the camshaft having a so-called limit configuration associated with a predetermined angular position, referred to as the limit angular position, when a predetermined voltage, referred to as the maximum voltage, is applied to said actuator for a predetermined duration Tb, the method comprising:
/a/ a step (Ea) of applying the maximum voltage to said electric actuator for a duration greater than the predetermined duration, then
/b1/ a step (Ed) of initiating a timer Ts, referred to as the safety timer, of a duration Tmax during which a maximum voltage continues to be applied to said actuator and, in parallel,
/b2/ a step (Es) of starting a synchronization of the combustion engine on the basis of position data associated with the limit angular position, then
/c/ if the timer expires before the end of the synchronization of the combustion engine, a step of incrementing the value of the failure counter and reiterating steps /a/ to /c/ if the value of the failure counter is less than a predetermined number Nmax,
otherwise the engine is synchronized and the supply of the limit voltage to said actuator is stopped (Estop).

2. The method according to claim 1, wherein the duration of application of the maximum voltage is determined on the basis of an angular rotation speed of the actuator and a maximum angular displacement in order to reach the limit angular position.

3. The method according to claim 1, comprising, prior to step /a/, a step (Ei) of determining that only electric actuators are available for synchronizing the engine.

4. A computer program product comprising program code instructions recorded on a computer-readable medium such as a processor, a controller or a microcontroller for implementing the steps of the method according to claim 1 when said program is implemented by said computer such as a processor, a controller or a microcontroller.

5. An electronic module for starting an internal combustion engine comprising a camshaft provided with an electric continuous variable valve timing device,
the electric device comprising an electric actuator configured to modify the angular position of the camshaft, the camshaft having a so-called limit configuration associated with a predetermined angular position, referred to as the limit angular position, when a predetermined voltage, referred to as the maximum voltage, is applied to said actuator for a predetermined duration Tb, the electronic module being configured to:
/a/ apply the maximum voltage to said electric actuator for a duration greater than the predetermined duration, then
/b1/ initiate a timer Ts, referred to as the safety timer, of a duration Tmax during which a maximum voltage continues to be applied to said actuator and, in parallel,
/b2/ starting a synchronization of the combustion engine on the basis of position data associated with the limit angular position, then
/c/ if the timer expires before the end of the synchronization of the combustion engine, incrementing the value of a failure counter and reiterating steps /a/ to /c/ if the value of the failure counter is less than a predetermined number Nmax,
otherwise, stopping the application of a voltage to said actuator, the combustion engine being synchronized.

6. A combustion engine, comprising an electronic module according to claim 5.

7. A vehicle comprising a combustion engine according to claim 6.

8. The computer program product according to claim 4, wherein said computer is a processor, a controller, or a microcontroller.

9. The method according to claim 2, comprising, prior to step /a/, a step (Ei) of determining that only electric actuators are available for synchronizing the engine.
